(19) United States
(12) Patent Application Publication
(10) Pub. No.: US 2025/0313697 A1
(43) Pub. Date: Oct. 9, 2025

(54) BINDERS WITH IMPROVED CURE KINETICS AND THERMAL PERFORMANCE FOR FIBROUS MATERIALS

(71) Applicant: JOHNS MANVILLE, Denver, CO (US)

(72) Inventors: Ameya Natu, Highlands Ranch, CO (US); Kiarash Alavi, Littleton, CO (US)

(21) Appl. No.: 18/627,589

(22) Filed: Apr. 5, 2024

(51) Int. Cl. C08L 77/06; C08F 220/06; C08F 222/02; C08J 5/04

(52) U.S. Cl. CPC C08L 77/06; C08F 220/06; C08F 222/02; C08J 5/04; C08J 2333/02; C08J 2377/06; C08L 2201/08; C08L 2312/00

(57) ABSTRACT

Binder compositions for fibrous materials, fibrous materials, and methods of forming fibrous materials are provided. Binder compositions for fibers materials include a beta-hydroxy alkyl amide crosslinked with a monomeric or polymeric polycarboxylic acid. Binder compositions exhibit a cure rate of greater than or about 4 MPa/C at 160° C.

### FIELD OF THE DISCLOSURE

The present technology relates to binder compositions for fibrous materials and to processes for making the same. The binder compositions include a beta-hydroxy alkyl amide and monomeric or polymeric polycarboxylic acid.

### BACKGROUND

Thermoset binders for fibrous materials, which may include insulation products, are moving away from traditional formaldehyde-based compositions. Formaldehyde is considered a probable human carcinogen, as well as an irritant and allergen, and its use is increasingly restricted in building products, textiles, upholstery, and other materials. In response, binder compositions have been developed that do not use formaldehyde or decompose to generate formaldehyde. Such binder compositions exhibit significantly decreased cure rates at standard curing temperatures. Decreased cure rates have led to uncured binder, which may be unstable, particularly at high temperatures. Uncured binder also negatively impacts mechanical performance of a final product. Therefore, existing formaldehyde-free binder compositions must be cured at higher temperatures by increasing curing oven temperatures. However, such high temperatures create excess volatile organic compounds during process, which is increasingly undesired as industries work towards decreased emissions. High oven temperatures may also increase the risk of exotherm and spontaneous combustion.

Thus, a need exists for binder compositions for fibrous materials having improved cure times and/or cure temperatures, such as formaldehyde-free binder compositions. Additionally, the need exists for binder compositions having improved thermal stability and/or enhanced exotherm resistance. These and other issues are disclosed in the present specification.

### BRIEF SUMMARY

The present technology is generally directed to binder compositions for fibrous materials. Binder compositions include a beta-hydroxy alkyl amide crosslinked with a monomeric or polymeric polycarboxylic acid. Binder compositions include a cure rate of greater than or about 4 MPa/C at 160° C.

In embodiments, the beta-hydroxy alkyl amide includes a reaction product of a primary or secondary alkanolamine or alkylalkanolamine and a monobasic or polybasic acid or anhydride. In more embodiments, the primary or secondary alkanolamine includes one or more hydroxy groups in a beta position relative to the amine. Furthermore, in embodiments, the primary or secondary alkanolamine or alkylalkanolamine includes ethanolamine, diethanolamine, propanolamine, isopropanolamine, dipropanolamine, diisopropanolamine, tris(hydroxymethyl)aminomethane, 3-amino-1,2-propanol, 2-amino-1,3-propanol, N-methylethanolamine, N-ethylethanolamine, N-benzylethanolamine, N-isopropylethanolamine, N-butylethanolamine, t-butylethanolamine or a combination thereof. Additionally or alternatively, in embodiments, the monobasic or polybasic acid or anhydride includes an aliphatic acid or anhydride, aromatic acid or anhydride, a cyclic acid or anhydride, or a combination thereof. In yet more embodiments, the monobasic or polybasic acid or anhydride includes acetic acid, acetic anhydride, propionic acid, propionic anhydride, benzoic acid, benzoic anhydride, phthalic acid, phthalic anhydride, terephthalic acid, terephthalic anhydride, oxalic acid, oxalic anhydride, succinic acid, succinic anhydride, adipic acid, adipic anhydride, tetrahydro phthalic acid, tetrahydro phthalic anhydride, trimellitic acid, trimellitic anhydride, citric acid, citric anhydride, butane-tetra carboxylic acid, butane-tetra carboxylic anhydride, benzophenone tetra carboxylic acid, benzophenone tetra carboxylic anhydride, or combinations thereof. Moreover, in embodiments, the monomeric or polymeric polycarboxylic acid includes a copolymer of acrylic acid and maleic acid. In further embodiments, the monomeric or polymeric polycarboxylic acid includes at least one homopolymer or copolymer comprising citric acid, succinic acid, itaconic acid, maleic acid, butane-tetracarboxylic acid, acrylic acid, maleic acid, itaconic acid, methacrylic acid, fumaric acid, crotonic acid, maleic anhydride, itaconic anhydride, or a combination thereof. In embodiments, the binder composition exhibits an exotherm onset temperature of greater than 275° C. In yet more embodiments, the binder composition includes a ratio of carboxyl groups to hydroxyl groups of greater than or about 0.5:1.

The present technology is also generally directed to fibrous materials. Fibrous materials include a cured binder composition that contains a beta-hydroxy alkyl amide crosslinked with a monomeric or polymeric polycarboxylic acid and a plurality of fibers. Fibrous materials include where the binder composition exhibits a cure rate of greater than or about 4 MPa/C at 160° C.

In embodiments, an unreacted portion of the homopolymer or copolymer of acrylic acid, or the copolymer of acrylic acid and maleic acid forms less than or about 5 wt. % of the cured binder. Moreover, in embodiments, the plurality of fibers includes organic fibers, glass fibers, mineral fibers, or combinations thereof. In further embodiments, the plurality of fibers include a fiber batt, a fiber mat, a fibrous nonwoven, or a combination thereof. Additionally or alternatively, in embodiments, the fibrous material include thermal insulation, acoustic insulation, or a combination thereof. In yet more embodiments, the fibrous material is thermally stable for a time greater than or about 100 minutes at a temperature of greater than or about 230° C.

The present technology is also generally directed to methods of making fibrous materials. Methods include forming a binder composition that includes reacting a monobasic or polybasic acid or anhydride with an alkanolamine to form a beta-hydroxy alkyl amide, and crosslinking the beta-hydroxy alkyl amide with a monomeric or polymeric polycarboxylic acid. Methods include contacting a plurality of fibers with the binder composition to form an amalgam of the binder composition and the plurality of fibers. Methods include curing the amalgam of the binder composition and the plurality of fibers at a temperature of less than or about 220° C. to form a mat of the plurality of fibers and the binder.

In embodiments, the fibrous materials include a humid-aged tensile strength of greater than or about 1.5 MPa. In further embodiments, the curing occurs for a time of 30 minutes or less. Moreover, in embodiments, the binder composition exhibits a cure rate of greater than or about 4 MPa/C at 160° C.

Additional embodiments and features are set forth in part in the description that follows, and in part will become apparent to those skilled in the art upon examination of the specification or may be learned by the practice of the invention. The features and advantages of the present technology may be realized and attained by means of the instrumentalities, combinations, and methods described in the specification.

### BRIEF DESCRIPTION OF THE DRAWINGS

A further understanding of the nature and advantages of the disclosed technology may be realized by reference to the remaining portions of the specification and the drawings.

FIG. 1 is a flowchart showing selected components and operations in a method of making fibrous materials according to embodiments of the present technology.

FIGS. 2A-C show simplified illustrations of exemplary composite materials according to embodiments of the present technology.

FIG. 3 shows a simplified schematic of an exemplary system for making fibrous materials according to embodiments of the present technology.

FIG. 4 is a flowchart that highlights some of the operations in a method of making fibrous materials according to embodiments of the present technology.

FIG. 5 is a graph showing tensile strength of hand-sheets prepared according to the examples herein.

FIG. 6 is a graph showing the dogbone tensile mechanical performance of samples prepared according to the examples herein.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

Various formaldehyde free binders for glass, mineral, and organic fibers (natural and synthetic) have been described in the literature and used for many years. As will be discussed in greater detail below, formaldehyde-free binders refer to binder systems with no added formaldehyde to the binder composition and/or which do not release formaldehyde during the insulation manufacturing process and/or that no detectable formaldehyde is released from the final product. One class of such binders is based on polyacrylic acid, including copolymers of acrylic acids, that are crosslinked with low molecular weight polyols such as triethanolamine or glycerol. Other binders are based on condensation of polyacrylic acid or low molecular weight polycarboxylic acids such as citric acid, with polyols such as starch or maltodextrin. These polymers have been commercialized since late 1990s for the fiber glass insulation industry.

Although these polymers provide mechanical performance of the insulation products that are comparable with phenol-formaldehyde (PF) resins, hydrolytic stability (moisture resistance) and thermal resistance of these polymers are not comparable with PF resins. Namely, existing binders based on polyols, such as triethanolamine, starch, or maltodextrin, lack thermal resistance at high temperatures, such as temperatures above 230° C., where such existing binder systems exothermically decompose. This renders existing polyol based binders unstable and unsuitable for high temperature applications.

In addition, existing polyacrylic acid-polyol based binder systems exhibit markedly slower cure rates than PF resins. Such low cure rates have proven problematic, as uneven binder distribution in the fibrous product may lead to uncured binder in binder-rich areas of the fibrous product, due at least in part to the slow cure kinetics. Uncured binder may decompose at lower temperatures than the overall product, rendering the fibrous product further thermally unstable. Attempts to improve the cure rates of existing polyacrylic acid-polyol based binders include utilizing increased cure temperatures or increasing the residence time in the curing temperature. However, increased cure temperatures and/or increased residence time have led to undesirable increases in volatile organic compound generation during curing, and increased risk of exotherm and spontaneous combustion, as discussed above.

In an effort to improve the cure kinetics of existing polyacrylic acid-polyol based binder systems, weight percentages of cure catalysts were increased and hydroxy content to carboxylic acid content was decreased. For instance, cure catalyst contents of 5 wt. % or more, as well as carboxylic acid to hydroxyl ratios of 2:1, were attempted. However, such efforts have still failed to increase the cure rates, particularly at low cure temperatures, of such binder compositions. Furthermore, existing polyacrylic acid based binder systems have still failed to provide consistent thermal performance, particularly at high temperatures.

The present technology overcomes these and other problems by providing binder compositions with increased cure rates, alone or in conjunction with lower cure temperatures, than existing polyacrylic acid based binder compositions. Namely, the present technology has surprisingly found that by replacing standard polyols in traditional polycarboxylic acid based binders with one or more beta-hydroxy alkyl amides and/or replacing traditional polyacrylic acids with an acrylic acid and maleic acid copolymer, unexpected increases in cure rate are exhibited by the binders discussed herein, often even at lower cure temperatures. Without wishing to be bound by theory, it is believed that the increased reactivity of the hydroxy groups in the beta-hydroxy alkyl amides and/or an acrylic acid and maleic acid copolymers discussed herein provide for greatly improved cure rates, alone or at reduced temperatures.

The binder compositions discussed herein may be suitable for use in fibrous materials, such as fiber-containing composites, nonwoven materials, or combinations thereof and methods of making such fibrous materials. Fibrous materials discussed herein may include insulation products, such as mats and batts, nonwoven mats or sheets, combinations thereof, and the like. The embodiments disclosed herein may also advantageously provide improved thermal stability while reducing cure time and/or cure temperature during the manufacture of fibrous materials. Fibrous materials discussed herein may also provide increased exotherm onset temperatures relative to fibrous materials formed with conventional binder compositions, while maintaining and at times increasing, desirable mechanical characteristics such as improved thermal stability.

As used herein, the term “crosslinking agent” refers to a compound having the ability to form a covalent bond or a short sequence of bonds that link one polymer chain to another polymer chain upon curing, e.g., to link two polyacrylic acid polymers to one another.

### Binder Compositions

Disclosed are binder compositions and processes for making such binder compositions as well as fibrous products including one or more of the cured binder compositions. As discussed above, the present technology has surprisingly found that polycarboxylic acid based binders exhibit significantly increased cure kinetics and thermal properties by utilizing a beta-hydroxy alkyl amide as a crosslinking agent, and/or by utilizing an acrylic acid and maleic acid co-polymer as the polycarboxylic acid.

The crosslinking agent for the polycarboxylic acid based binders according to the present technology may therefore include one or more beta-hydroxy alkyl amides. In embodiments, beta-hydroxy alkyl amides may include one or more reaction products of a monobasic or polybasic acid or anhydride with a primary or secondary alkanolamine or alkylalkanolamine.

As used herein, “polybasic acid” may refer to one or more acids having the general formula R′—OOC—Y—COO—R″ for dibasic, wherein R′ and R″ are hydrogen, and Y denotes any organic compound (such as an alkyl, aryl, or silyl group), including organic compounds having one or more heteroatom substituent groups, and with one, or two more R′—OOC groups for tribasic and tetrabasic acids, and where a monobasic acid may only include one R′—OOC group. In embodiments, Y may be or include a saturated or unsaturated hydrocarbon.

Monobasic and polybasic acids discussed herein may include acetic acid, propionic, benzoic acid, oxalic acid, malonic acid, succinic acid, glutaric acid, adipic acid, pimelic acid, suberic acid, azelaic acid, sebacic acid, citric acid, trimellitic acid, butane-tetra carboxylic acid, benzophenone tetra carboxylic acid, phthalic acid, tetrahydro phthalic, isophthalic acid, terephthalic acid, naphthalenedicarboxylic acid, 1,2-cyclohexanedicarboxylic acid, 1,3-cyclohexanedicarboxylic acid, 1,4-cyclohexanedicarboxylic acid, 4-cyclohexene-1,2-dicarboxylic acid, 3-methyl-1,2-cyclohexanedicarboxylic acid, 4-methyl-1,2-cyclohexanedicarboxylic acid, 1,2,4-cyclohexanetricarboxylic acid, 1,3,5-cyclohexanetricarboxylic acid, or combinations thereof.

In embodiments, examples of anhydrides as discussed herein may include one or more anhydrides of the monobasic and/or polybasic acids discussed above, including the anhydrides of aliphatic monobasic or polybasic acids, the anhydrides of alicyclic monobasic or polybasic acids, and the anhydrides of aromatic monobasic or polybasic acids, and the like, as well as combinations thereof. For instance, in embodiments, the polybasic acid may include one or more of the above discussed monobasic and/or polybasic acids.

In embodiments, monobasic or polybasic acids or anhydrides discussed herein may include acetic acid, acetic anhydride, propionic acid, propionic anhydride, benzoic acid, benzoic anhydride, phthalic acid, phthalic anhydride, terephthalic acid, terephthalic anhydride, oxalic acid, oxalic anhydride, succinic acid, succinic anhydride, adipic acid, adipic anhydride, tetrahydro phthalic acid, tetrahydro phthalic anhydride, trimellitic acid, trimellitic anhydride (TMA), citric acid, citric anhydride, butane-tetra carboxylic acid, butane-tetra carboxylic anhydride, benzophenone tetra carboxylic acid, benzophenone tetra carboxylic anhydride, or combinations thereof.

Regardless of the monobasic or polybasic acid or anhydride selected, the monobasic or polybasic acid or anhydride may be reacted with one or more primary or secondary alkanolamines or alkylalkanolamine containing at least one reactive —NH group and one hydroxyl group, such as at a reaction temperature of about 90° C. to about 100° C. for about 2 hours to about 5 hours, to form the beta-hydroxy alkyl amides discussed herein. The ratio of acid or anhydride groups to the —NH groups of the alkanolamine and/or alkylalkanolamine is typically about 1:1 However, in embodiments, a slight excess of amine may be preferred. In embodiments, suitable alkanolamines and/or alkylalkanolamine include monoethanolamine (MEA), diethanolamine (DEA), propanolamine, isopropanolamine, dipropanolamine, diisopropanolamine (DIPA), tris(hydroxymethyl)aminomethane, 3-amino-1,2-propanol, 2-amino-1,3-propanol, N-methylethanolamine, N-ethylethanolamine, N-benzylethanolamine, N-isopropylethanolamine, N-butylethanolamine, t-butylethanolamine, or combinations thereof. In embodiments, the primary or secondary alkanolamines utilized herein may contain one or more hydroxy groups in the beta position relative to the amine.

For instance, in embodiments, beta-hydroxy alkyl amides may include one or more aliphatic beta-hydroxy alkyl amides, one or more aromatic beta-hydroxy alkyl amides, or combinations thereof. Exemplary beta-hydroxy alkyl amides may include commercially available n,n,n′,n′-Tetrakis(2-hydroxyethyl)adipamide (HAA), a reaction product of adipic acid with diethanolamine (1:2 mole ratio):

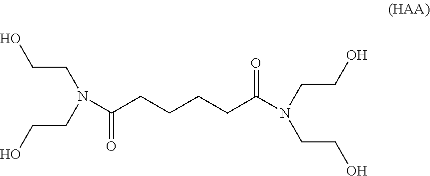 [SMILES: O=C(CCCCC(=O)N(CCO)CCO)N(CCO)CCO]

A reaction product of trimellitic anhydride-diethanolamine (TMA-3DEA, 1:3 mole ratio, structure II):

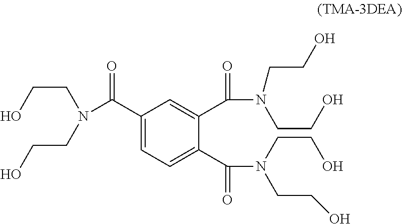 [SMILES: O=C(c1ccc(C(=O)N(CCO)CCO)c(C(=O)N(CCO)CCO)c1)N(CCO)CCO]

A reaction product of trimellitic anhydride-diethanolamine (TMA-DEA, 1:1 mole ratio, structure III):

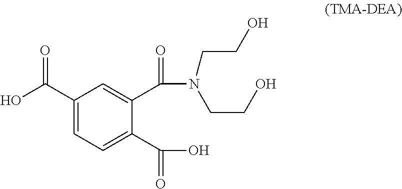 [SMILES: O=C(O)c1ccc(C(=O)O)c(C(=O)N(CCO)CCO)c1]

A reaction product of citric acid-diethanolamine (structure IV, 1:3 mole ratio):

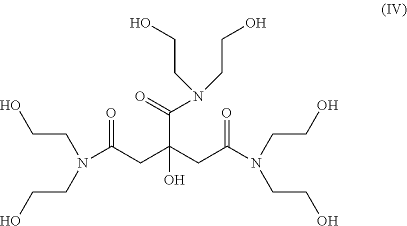 [SMILES: O=C(CC(O)(CC(=O)N(CCO)CCO)C(=O)N(CCO)CCO)N(CCO)CCO]

A reaction product of acetic acid-diethanolamine (structure V, 1:1 mole ratio):

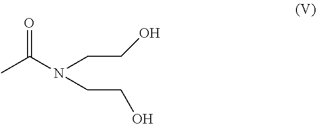

A reaction product of phthalic acid-diethanolamine (structure VI, 1:2 mole ratio):

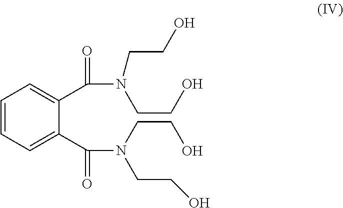 [SMILES: O=C(c1ccccc1C(=O)N(CCO)CCO)N(CCO)CCO]

A reaction product of phthalic anhydride-diethanolamine (structure VII, 1:1 mole ratio):

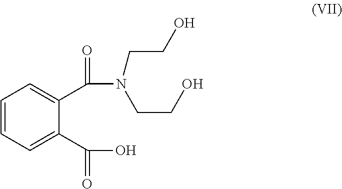 [SMILES: O=C(O)c1ccccc1C(=O)N(CCO)CCO]

A reaction product of benzoic acid-diethanolamine (structure VIII, 1:1 mole ratio):

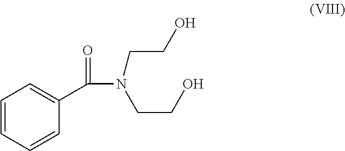 [SMILES: O=C(c1ccccc1)N(CCO)CCO]

However, it should be noted that the above structures are illustrated as examples only, as other beta-hydroxy alkyl amides are contemplated as discussed above in regards to combinations of acids or anhydrides with alkanolamines described herein.

Regardless of the final beta-hydroxy alkyl amide formed or selected, the beta-hydroxy alkyl amide may be utilized as a crosslinking agent for one or more polycarboxylic acids in binder compositions discussed herein. Moreover, in embodiments, the beta-hydroxy alkyl amides discussed herein may form some or all of the crosslinking agent. In embodiments, the crosslinking agent may contain little to no non-beta-hydroxy alkyl amide polyols, e.g., little to no polyol content that does not contain a reaction product of a carboxylic acid or anhydride reacted with a primary or sectary containing amino alcohol as discussed above. For instance, in embodiments, the one or more beta-hydroxy alkyl amides may form greater than or about 50 wt. % of the crosslinking agent (e.g. polyol component) based upon the weight of the crosslinking agent in the binder composition, such as greater than or about 55 wt. %, such as greater than or about 60 wt. %, such as greater than or about 65 wt. %, greater than or about 70 wt. %, greater than or about 75 wt. %, greater than or about 80 wt. %, greater than or about 85 wt. %, greater than or about 90 wt. %, greater than or about 92.5 wt. %, greater than or about 95 wt. %, greater than or about 97.5 wt. %, greater than or about 99 wt. %, greater than or about 99.5 wt. %, greater than or about 99.9 wt. %, or any ranges or values therebetween.

Moreover, in embodiments, the beta-hydroxy alkyl amine may form greater than or about 20 wt. % up to about 100 wt. % of the total dry binder solids, such as greater than or about 25 wt. %, greater than or about 30 wt. %, greater than or about 35 wt. %, greater than or about 40 wt. %, greater than or about 45 wt. %, greater than or about 50 wt. %, greater than or about 55 wt. %, greater than or about 60 wt. %, greater than or about 65 wt. %, greater than or about 70 wt. %, greater than or about 75 wt. %, greater than or about 80 wt. %, or less than or about 95 wt. %, less than or about 90 wt. %, less than or about 85 wt. %, less than or about 80 wt. %, less than or about 75 wt. %, less than or about 70 wt. %, or any ranges or values therebetween.

The polymer compound may be a solution polymer that helps make a rigid thermoset binder when cured. In contrast, when the polymer compound is an emulsion polymer, the final binder compositions are usually less rigid (i.e., more flexible) at room temperature.

The polymer to be crosslinked upon curing may include a monomeric or polymeric polycarboxylic acid. Although the subject specification primarily refers to acrylic acid polymers, the polycarboxylic acids crosslinked according to the embodiments of the disclosure may include any polycarboxylic acid monomer, or any polycarboxylic acid homopolymer, and/or copolymer prepared from ethylenically unsaturated carboxylic acids including, but not limited to, acrylic acid, methacrylic acid, butenedioic acid (i.e., maleic acid and/or fumaric acid), methyl maleic acid, itaconic acid, and crotonic acid, among other carboxylic acids. The polycarboxylic acid polymer may also be prepared from ethylenically unsaturated acid anhydrides including, but not limited to, maleic anhydride, acrylic anhydride, methacrylic anhydride, itaconic anhydride, among other acid anhydrides.

Thus, in some aspects the polycarboxylic acid based binder includes a monomeric polycarboxylic acid such as citric acid, itaconic acid, maleic acid, adipic acid, oxalic acid, trimellitic acid, and butanetetracarboxylic acid. In other aspects, the polycarboxylic acid may include a homopolymer or copolymer formed at least in part from acrylic acid, methacrylic acid, butenedioic acid, methyl maleic acid, itaconic acid, crotonic acid, maleic anhydride, acrylic anhydride, methacrylic anhydride, itaconic anhydride, maleic acid, or fumaric acid. Additionally, the polycarboxylic acid polymer of the present invention may be a copolymer of one or more of the aforementioned unsaturated carboxylic acids or acid anhydrides and one or more vinyl compounds including, but not limited to, styrenes, acrylates, methacrylates, acrylonitriles, methacrylonitriles, among other compounds. More specific examples of the polycarboxylic acid polymer may include copolymers of styrene and maleic anhydride, and its derivatives including its reaction products with ammonia and/or amines. For example, the polycarboxylic acid polymer may be the polyamic acid formed by the reaction between the copolymer of styrene and maleic anhydride and ammonia.

Nonetheless, in embodiments, the polycarboxylic acid in the present binder compositions may include a polymeric polycarboxylic acid having a molecular weight of greater than or about 1000 Daltons, greater than or about 2000 Daltons, greater than or about 3000 Daltons, greater than or about 4000 Daltons, greater than or about 5000 Daltons, or more. In still further embodiments, the polymeric polycarboxylic acid may have a molecular weight of less than or about 10,000 Daltons, less than or about 9000 Daltons, less than or about 8000 Daltons, less than or about 7000 Daltons, less than or about 6000 Daltons, less than or about 5000 Daltons, or less. In embodiments, the polymeric polycarboxylic acid may be made from unsaturated polycarboxylic acid monomers and/or oligomers.

In embodiments, the polymeric polycarboxylic acid may be a polyacrylic acid polymer. In further embodiments, the polyacrylic acid polymer may be at least one of a polyacrylic acid homopolymer and a polyacrylic acid copolymer. In yet further embodiments, the polyacrylic acid copolymer may include a copolymer of acrylic acid and at least one or more ethylenically unsaturated acids and anhydrides such as methacrylic acid, acrylic acid, crotonic acid, fumaric acid, maleic acid, maleic anhydride, 2-methyl maleic acid, itaconic acid, itaconic anhydride, 2-methyl itaconic acid, and α,β-methylene glutaric acid. In yet further embodiments, the polymeric polycarboxylic acid may be one or more of a polyacrylic acid polymer, a polyacrylic acid-maleic acid copolymer, a butane tetracarboxylic acid copolymer, and a polymaleic acid polymer. In still further embodiments, the polymeric polycarboxylic acid may comprise at least one homopolymer or copolymer selected from the group consisting of acrylic acid, maleic acid, itaconic acid, and methacrylic acid, such as, in embodiments, a homopolymer of acrylic acid, a copolymer of acrylic acid and maleic acid, or a combination thereof.

In embodiments, the combination of the one or more beta-hydroxy alkyl amides and the polymeric polycarboxylic acids may give the binder composition a mole ratio of carboxylic acid groups to hydroxyl groups that is greater than or about 0.5:1, greater than or about 0.6:1, greater than or about 0.7:1, greater than or about 0.8:1, greater than or about 0.9:1, greater than or about 1.0:1, greater than or about 1.1:1, greater than or about 1.2:1, greater than or about 1.3:1, greater than or about 1.4:1, greater than or about 1.5:1, greater than or about 1.6:1, greater than or about 1.7:1, greater than or about 1.8:1, greater than or about 1.9:1, greater than or about 2.0:1, greater than or about 2.1:1, greater than or about 2.2:1, greater than or about 2.3:1, greater than or about 2:4:1, greater than or about 2.5:1, greater than or about 2.6:1, greater than or about 2.7:1, greater than or about 2.8:1, greater than or about 2.9:1, greater than or about 3.0:1, greater than or about 3.1:1, greater than or about 3.2:1, greater than or about 3.3:1, greater than or about 3:4:1, greater than or about 3.5:1, greater than or about 3.6:1, greater than or about 3.7:1, greater than or about 3.8:1, greater than or about 3.9:1, up to about 4.0:1, or any ranges or values therebetween. In embodiments, a mole ratio of carboxylic acid groups to hydroxyl groups may be from about 1.5:1 to about 2.5:1, such as from about 1.6:1 to about 2.4:1, such as from about 1.7:1 to about 2.3:1, such as from about 1.8:1 to about 2.2:1, such as from about 1.9:1 to about 2.1:1, or any ranges or values therebetween. Namely, in embodiment, having a slightly greater amount of carboxyl groups, without greatly exceeding the amount of hydroxy groups, may further improve the cure kinetics and thermal stability of the binder.

In embodiments, the beta-hydroxy alkyl amide and the polymeric polycarboxylic acid compounds may represent the majority of the compounds in the binder. In embodiments, the binder composition may be an aqueous binder composition. In embodiments, the total solids level of the one or more beta-hydroxy alkyl amides in the binder composition may be greater than or about 5 wt. %, greater than or about 10 wt. %, greater than or about 20 wt. %, greater than or about 30 wt. %, greater than or about 35 wt. %, greater than or about 40 wt. %, greater than or about 45 wt. %, greater than or about 50 wt. %, greater than or about 55 wt. %, greater than or about 60 wt. %, greater than or about 65 wt. %, greater than or about 70 wt. %, greater than or about 75 wt. %, or more, based upon the weight of total solids in the aqueous binder.

Moreover, in embodiments, the total solids level of the one or more polymeric polycarboxylic acid compounds in the binder composition may be less than or about 50 wt. %, less than or about 45 wt. %, less than or about 40 wt. %, less than or about 35 wt. %, less than or about 30 wt. %, less than or about 25 wt. %, less than or about 20 wt. %, less than or about 10 wt. %, less than or about 5 wt. %, or less, based upon the weight of total solids in the aqueous binder.

Furthermore, in embodiments, the one or more beta-hydroxy alkyl amides and the one or more polymeric polycarboxylic acid compounds may have a combined total solids level in the binder composition of greater than or about 5 wt. %, greater than or about 10 wt. %, greater than or about 15 wt. %, greater than or about 20 wt. %, greater than or about 25 wt. %, greater than or about 30 wt. %, greater than or about 35 wt. %, greater than or about 40 wt. %, greater than or about 45 wt. %, greater than or about 50 wt. %, greater than or about 55 wt. %, greater than or about 60 wt. %, greater than or about 70 wt. %, greater than or about 80 wt. %, greater than or about 90 wt. %, greater than or about 95 wt. %, or more based upon the weight of total solids in the aqueous binder.

Nonetheless, in embodiments, the binder composition may include one or more additional components, such as an optional cure catalyst. Examples of cure catalysts may include phosphorous-containing compounds such as phosphorous oxyacids and their salts. For example, the cure catalyst may be an alkali metal hypophosphite salt like sodium hypophosphite (SHP). The cure catalyst may be added to expedite curing of the binder composition. However, as discussed above, the binder compositions of the present technology may exhibit surprisingly increased cure kinetics, even at decreased cure temperatures. Thus, in embodiments, the binder compositions discussed herein may be essentially free or free of one or more catalysts such as alkali metal salts of phosphorous-containing acids like phosphorous acid (e.g., sodium and potassium phosphate), hypophosphorous acid (e.g., sodium and potassium hypophosphite), and polyphosphoric acid (e.g., sodium and potassium polyphosphate), sodium and potassium pyrophosphate, sodium and potassium hexametaphosphate, sulfuric acid, p-toluenesulfonic acid, sodium sulfate, sodium nitrite, sodium carbonate, boric acid, and fluoroborate compounds, polyethyleneimine, diethylamine, and triethylamine, among other catalyst compounds.

In embodiments, the binder composition may include one or more additional compounds such as coupling agents, dust suppression agents, biocides, deodorants, antioxidants, dyes, pigments, colorants, UV stabilizers, corrosion inhibitors, lubricants, wetting agents, antistatic agents, water repelling agents, emulsifiers, anti-foaming agents, preservatives, vegetable oils, and surfactants, among other additional compounds. In further embodiments, the additional compounds may be added to the present binder compositions in an amount greater than or about 0.1 wt. % of the binder composition, greater than or about 0.5 wt. %, greater than or about 1 wt. %, greater than or about 2.5 wt. %, greater than or about 5 wt. %, greater than or about 7.5 wt. %, greater than or about 10 wt. %, or more. In yet further embodiments, the additional compounds may be added to the present binder compositions in an amount less than or about 10 wt. %, less than or about 5 wt. %, less than or about 2.5 wt. %, less than or about 1 wt. %, or less. The binder compositions may also optionally include extenders. Examples of extenders may include starch, lignin, rosin, among other extenders.

In embodiments, for instance, when glass fibers may be utilized, the coupling agent in the present binder compositions may be a silicon-containing coupling agent to increase bonding between the glass fibers and the cured binder. In additional embodiments, the silicon-containing coupling agent may be a silane coupling agent. In yet additional embodiments, the silane coupling agent may be selected from aminosilanes (e.g., triethoxyaminopropylsilane, 3-aminopropyl-triethoxysilane, 3-aminopropyl-trihydroxysilane, γ-aminopropyltriethoxysilane), epoxy trialkoxysilanes (e.g., 3-glycidoxypropyltrimethoxysilane, 3-glycidoxypropyltriethoxysilane), methyacryl trialkoxysilanes (e.g., 3-methacryloxypropyltrimethoxysilane, 3-methacryloxypropyltriethoxysilane), hydrocarbon trialkoxysilanes, amino trihydroxysilanes, epoxy trihydroxysilanes, methacryl trihydroxy silanes, and hydrocarbon trihydroxysilanes.

The binder compositions may also optionally contain pH adjustment agents. For example, the present binder compositions and solution may include one or more acids or bases that maintain the pH between 2-8.

Surprisingly, the binder compositions according to the present technology exhibit increased cure kinetics, which, in embodiments, are exhibited even at low temperatures. Thus, in embodiments, the binder compositions according to the present technology may be cured at temperatures less than 220° C., such as less than or about 215° C., less than or about 210° C., less than or about 205° C., less than or about 200° C., less than or about 195° C., less than or about 190° C., less than or about 185° C., less than or about 180° C., less than or about 175° C., less than or about 170° C., less than or about 169° C., less than or about 168° C., less than or about 167° C., less than or about 166° C., less than or about 165° C., less than or about 164° C., less than or about 163° C., less than or about 162° C., less than or about 161° C., less than or about 160° C., or such as about 160° C. or more, or any ranges or values therebetween.

Moreover, surprisingly, the binder compositions according to the present technology may exhibit excellent cure rates as measured utilizing the Dynamic Mechanical Analysis instrument and method discussed in the examples below, even at any one or more of the above cure temperatures, such as greater than or about 4 MPa/C, greater than or about 4.5 MPa/C, greater than or about 5 MPa/C, greater than or about 5.5 MPa/C, greater than or about 6 MPa/C, greater than or about 6.5 MPa/C, greater than or about 7 MPa/C, greater than or about 7.5 MPa/C, greater than or about 8 MPa/C, greater than or about 8.5 MPa/C, greater than or about 9 MPa/C, greater than or about 9.5 MPa/C, greater than or about 10 MPa/C, greater than or about 10.5 MPa/C, greater than or about 11 MPa/C, greater than or about 11.5 MPa/C, greater than or about 12 MPa/C, greater than or about 13 MPa/C, greater than or about 14 MPa/C, greater than or about 15 MPa/C, or such as less than or about 15 MPa/C, less than or about 14 MPa/C, less than or about 13 MPa/C, or any ranges or values therebetween.

### Fibrous Materials and Methods of Making Fibrous Materials

The present binder compositions may be used in fibrous materials, as well as methods of making fibrous materials. Fibrous materials may be one or more fiber-containing products, which may be an amalgam of one or more types of fibers and the binder composition that is cured to form the product. Unless otherwise indicated, the concentrations of the components of the binder compositions are a dry weight percentage that excludes the weight of a solvent. In some embodiments, the present binder compositions are aqueous, and the solvent is water. In some embodiments, the binder composition is a clear to translucent aqueous solution. The relative concentration of solids in the solvent (i.e. total solids) may range from about 5 wt. % to about 75 wt. % based on the total weight of the binder composition. More specific ranges of the total solids include about 5 wt. % to about 50 wt. %; about 10 wt. % to about 70 wt. %; about 10 wt. % to about 40 wt. %; about 30 to about 60 wt. %; about 40 to about 50 wt. %, among other ranges, as well as any ranges or values therebetween. Specific exemplary total solids concentrations based on the weight of the binder composition include about 10 wt. %, about 15 wt. %, about 20 wt. %, about 25 wt. %, about 30 wt. %, about 35 wt. %, about 40 wt. %, about 45 wt. %, about 50 wt. %, about 55 wt. %; about 60 wt. %; about 65 wt. %; about 70 wt. %; and about 75 wt. %, as well as any ranges or values therebetween, among other concentrations.

In embodiments of the present technology, the fibrous material may be made from an amalgam of the fibers and the binder composition that is cured to form the product. In embodiments, the amount of cured binder in the fibrous material may be greater than or about 5 wt. % of the fiber-containing product, greater than or about 10 wt. %, greater than or about 15 wt. %, greater than or about 20 wt. %, or more. In embodiments, the amount of cured binder in the fiber-containing product may be less than or about 30 wt. %, less than or about 25 wt. %, less than or about 20 wt. %, less than or about 15 wt. %, less than or about 10 wt. %, less than or about 5 wt. %, or less. The amount of cured binder in the fiber-containing product may be measured as a loss on ignition (LOI) from the fiber-containing product.

As noted above, embodiments of the present fibrous materials may produce fewer volatile gasses, due at least in part to the increased cure kinetics and compatibly with curing at lower temperatures, and may also yield more consistently fully cured fiber-containing products. This can make embodiments of the present materials well suited as thermal insulation for articles that experience high temperatures such as hot pipes, ovens, dryers, and dishwashers, among other articles. The cured binder's thermal stability may be measured as a function of the heat released from the binder over time at a particular temperature. As described below, exotherm data may be collected from cured binders by measuring the amount of heat released over a period of time as the binder is kept at a fixed temperature. In some embodiments, the exotherm data shows a peak heat release time that may be correlated to a time when the binder becomes thermally unstable and undergoes uncontrolled combustion in an oxygen-containing atmosphere (e.g., air). A binder that reaches peak heat release earlier in time may be characterized as less thermally stable than a binder reaching peak heat release later in time. In some embodiments, the exotherm data does not show a peak heat release over the time recorded for the binder at that temperature. In those embodiments, the binder may be permanently thermally stable at that temperature.

In embodiments, the fibrous material may be thermally stable for a time greater than or about 100 minutes at temperatures greater than or about 230° C. In further embodiments, the binders may be thermally stable for a time greater than or about 100 minutes at temperatures greater than or about 235° C., greater than or about 240° C., greater than or about 250° C., greater than or about 260° C., greater than or about 270° C., or more, or any ranges or values therebetween, such as less than or about 400° C., less than or about 375° C., less than or about 350° C., less than or about 325° C., less than or about 300° C., less than or about 275° C., less than or about 250° C., or any ranges or values therebetween. In embodiments, the present cured binders in the fibrous materials may exhibit permanent thermal stability, as shown by a plot of exotherm data, for temperatures less than or about 250° C., less than or about 245° C., less than or about 240° C., less than or about 235° C., less than or about 230° C., less than or about 225° C., less than or about 220° C., or less, or any ranges or values therebetween.

In embodiments, the increased thermal stability of the cured binder may be accompanied by increased mechanical strength of the fibrous materials. In embodiments, the fiber-containing products may have unaged tensile strength of greater than or about 3 megapascals (MPa), greater than or about 3.1 MPa, greater than or about 3.2 MPa, greater than or about 3.3 MPa, greater than or about 3.4 MPa, greater than or about 3.5 MPa, greater than or about 3.6 MPa, greater than or about 3.7 MPa, greater than or about 3.8 MPa, greater than or about 3.9 MPa, greater than or about 4.0 MPa, greater than or about 4.1 MPA, greater than or about 4.2 MPA, or any ranges or values therebetween.

In additional embodiments, the fibrous materials may have a humid-aged tensile strength of greater than or about 1.5 MPa, greater than or about 1.6 MPa, greater than or about 1.7 MPa, greater than or about 1.8 MPa, greater than or about 1.9 MPa, greater than or about 2 MPa, greater than or about 2.1 MPa, greater than or about 2.2 MPa, or any ranges or values therebetween.

In embodiments, the cured binders in the fibrous materials may be characterized by a humid-aged retention greater than or about 35%, greater than or about 40%, greater than or about 45%, greater than or about 50%, greater than or about 55%, greater than or about 60%, greater than or about 65%, greater than or about 70%, greater than or about 75%, or any ranges or values therebetween.

Embodiments of the present technology includes methods of making fibrous materials that includes a cured binder made from a binder composition having a beta-hydroxy alkyl amide and a monomeric or polymeric polycarboxylic acid and/or an acrylic acid and maleic acid co-polymer. As noted above, the types and relative amounts of the beta-hydroxy alkyl amide and polymeric polycarboxylic acid may be selected to cure the binder composition in shorter curing times and lower curing temperatures than conventional binder compositions. In embodiments, the present binder compositions can achieve these improved curing conditions without adding conventional polymerization agents to the compositions.

In some embodiments, the binder composition may contact the fibers by one or more application operations such as spraying the binder composition on the fibers, curtain coating, spin-curtain coating, and dip-roll coating, among other application operations. The binder composition may contact freshly formed fibers that are above room temperature, or fibers that have cooled and been processed by, for example, cutting, pressing, and/or sizing, among other types of processing. In embodiments, the binder composition may be applied to fibers before they are organized into a mat or batt, while in additional embodiments the binder composition may be applied to the fibers after they are organized into a mat or batt. Fibers may include natural and/or synthetic fibers of a variety of lengths. For instance, in embodiments, fibers may include glass fibers, mineral fibers, organic fibers (including carbon fibers), combinations thereof, and the like. The fiber length may be selected based upon the fibrous product, a nonwoven material may contain longer fibers whereas an insulation material may include one or more short fiber lengths. The fibers may be arranged as an insulation batt, woven mat, non-woven mat, or spunbond product, among other types of fiber substrate.

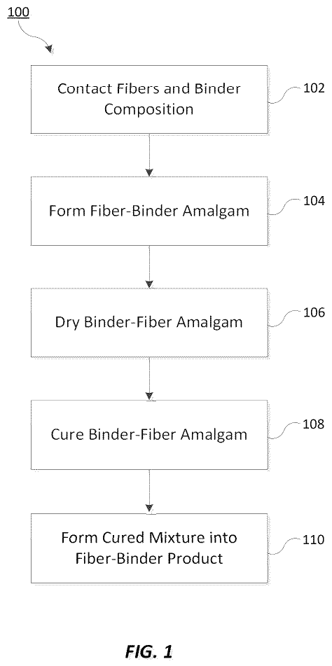

FIG. 1 shows a flowchart that highlights some of the operations in a method 100 of making fibrous materials according to embodiments. The method 100 includes contacting fibers with a binder composition at operation 102. In some embodiments, the binder composition may contact the fibers by one or more application operations such as spraying the binder composition on the fibers, curtain coating, spin-curtain coating, and dip-roll coating, among other application operations. The binder composition may contact freshly formed fibers that are above room temperature, or fibers that have cooled and been processed by, for example, cutting, pressing, and/or sizing, among other types of processing. In embodiments, the binder composition may be applied to fibers before they are organized into a mat or batt, while in additional embodiments the binder composition may be applied to the fibers after they are organized into a mat or batt, or other forms discussed herein.

The method 100 may further include forming the combination of fibers and binder composition into a fiber-binder amalgam at operation 104. In embodiments, the fiber-binder amalgam may be formed by placing the binder-coated fibers on a conveyor belt where they form a mat or batt of the amalgam. In additional embodiments, the fiber-binder amalgam is formed when the binder composition is applied to a mat or batt of the uncoated fibers that sit on a conveyor belt. However, in embodiments, it should be clear that the fibrous material may be hydroformed or co-formed, prior to disposition of the fibrous material on the conveyor or surface.

In embodiments, method 100 may also include a drying operation 106 that removes some of the water from the binder composition in the fiber-binder amalgam. In some embodiments, the drying operation 106 may include blowing a gas onto or through the fiber-binder amalgam. In embodiments, the gas may be heated to a temperature greater than or about 30° C., greater than or about 40° C., greater than or about 50° C., greater than or about 60° C., greater than or about 70° C., greater than or about 80° C., greater than or about 90° C., or more. In further embodiments, the gas may be air. In yet further embodiments, the fiber-binder amalgam may sit on a conveyor belt that is made of an air permeable material such as a wire screen or perforated belt that permits gases to pass through the belt. In still additional embodiments, the drying gas may be blown down on the fiber-binder amalgam from above, or it may be blown up through the fiber-binder amalgam from below.

The method 100 may still further include curing the fiber-binder amalgam in a curing operation 108. In embodiments, the curing operation 108 may be conducted by transporting the fiber-binder amalgam to a curing oven to raise the amalgam to a curing temperature for a curing time. In further embodiments, the curing oven may heat the fiber-binder amalgam to a curing temperature that is greater than or about 160° C., greater than or about 170° C., greater than or about 180° C., greater than or about 190° C., greater than or about 200° C., greater than or about 210° C., greater than or about 220° C., greater than or about 230° C., greater than or about 240° C., greater than or about 255° C., or any ranges or values therebetween. In additional embodiments, the curing oven may heat the fiber-binder amalgam to a curing temperature that is less than or about 250° C., less than or about 240° C., less than or about 230° C., less than or about 225° C., less than or about 220° C., less than or about 215° C., less than or about 210° C., less than or about 205° C., less than or about 200° C., or any ranges or values therebetween. In still further embodiments, the curing oven may heat the curing binder-fiber amalgam for a curing time that is less than or about 30 minutes, less than or about 25 minutes, less than or about 20 minutes, less than or about 15 minutes, less than or about 10 minutes, less than or about 7.5 minutes, less than or about 5 minutes, less than or about 2.5 minutes, less than or about 1 minute, less than or about 0.5 minutes, or less.

In embodiments, the present fiber-binder amalgams made with binder compositions discussed herein may be characterized by peak cure temperatures that are less than a peak cure temperature of a comparable binder-fiber amalgam that lacks a beta-hydroxy alkyl amide and/or an acrylic acid and maleic acid copolymer in the binder composition. In embodiments, the peak cure temperature of the present binder-fiber amalgam may be 5° C. less, 10° C. less, 15° C. less, 20° C. less, 25° C. less, 30° C. less, or less than the peak cure temperature of a comparable binder-fiber amalgam that lacks a beta-hydroxy alkyl amide and/or an acrylic acid and maleic acid copolymer.

In embodiments, the amount of polymeric polycarboxylic acid that has not reacted with the beta-hydroxy alkyl amides in the cured binder may be less than or about 5 wt. % of the cured binder, less than or about 4 wt. %, less than or about 3 wt. %, less than or about 2 wt. %, less than or about 1 wt. %, less than or about 0.5 wt. %, less than or about 0.1 wt. %, or any ranges or values therebetween. As noted above, these high rates of polymerization of the beta-hydroxy alkyl amide and polymeric polycarboxylic acid reactants may be achieved with embodiments of the binder composition that does not include elevated curing temperatures or times.

In further embodiments, the extent of polymerization in the cured binder may be characterized by the mole ratio of free acid groups (i.e., free —COOH groups) to ester groups formed by the reaction of the acid groups of the polymeric polycarboxylic acid with the hydroxyl groups of the beta-hydroxy alkyl amide. In embodiments, the cured binder may be characterized by a mole ratio of acid groups to ester groups that may be less than or about 1:1, less than or about 1:2, less than or about 1:3, less than or about 1:4, less than or about 1:5, less than or about 1:6, less than or about 1:7, less than or about 1:8, less than or about 1:9, less than or about 1:10, or less.

The method 100 may yet further include one or more finishing operations 110 that form the mixture or fibers and cured binder into the fibrous materials. In embodiments, these finishing operations 110 may include shaping the mixture of fibers and cured binder, compacting the mixture, adding a facer to the mixture, and packaging the mixture, among other finishing operations.

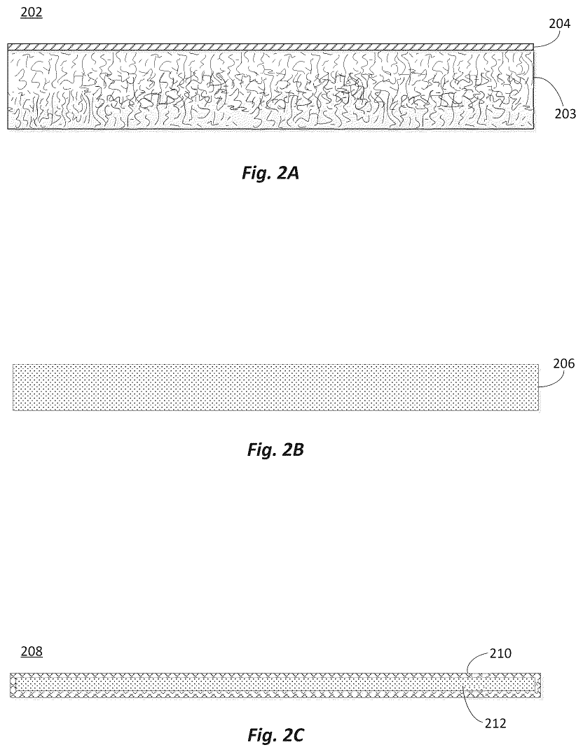

Embodiments of method 100 may produce fiber-containing products like the ones shown in FIGS. 2A-C. FIG. 2A shows a simplified schematic of an insulation batt or blanket material 202 according to an embodiment of the present fibrous materials. In embodiments, the insulation blanket material 202 may include non-woven fibers held together by the cured binder. The fibers may be glass fibers used to make fiberglass insulation (e.g, fiberglass for aircraft insulation), or a blend of two or more types of fibers, such as a blend of glass fibers and organic polymer fibers, among other types of fibers. In additional embodiments, a facer 204 may be attached to one or more surfaces of the batt/blanket 203. In some embodiments, the batt/blanket may have a thickness from 0.375 inches to 2.0 inches, preferably from 0.5 inches to 2.0 inches. In further embodiments, the batt/blanket 203 may have a thickness greater than or about 1 cm, greater than or about 5 cm, greater than or about 10 cm, greater than or about 20 cm, greater than or about 30 cm, greater than or about 40 cm, or more. In additional embodiments, the batt/blanket 203 may have a thickness less than or about 40 cm, less than or about 30 cm, less than or about 20 cm, less than or about 10 cm, or less. Thus, in some embodiments, the batt/blanket 203 can have a thickness from 1 cm to 40 cm, from 5 cm to 30 cm, or from 10 cm to 25 cm. In some embodiments the batt/blanket can have a density from 0.20 to 2.0 lbs/ft³, preferably from 0.34 to 1.5 lbs/ft³.

FIG. 2B is a simplified schematic of a fiber-containing composite board 206 that may be used as an insulation board, duct board, elevated temperature board, etc. according to embodiments of the present fiber-containing product. In embodiments, the fibers in board 206 may include glass fibers, organic polymer fibers, carbon fibers, mineral fibers, metal fibers, among other types of fibers, and blends of two or more types of fibers.

FIG. 2C is a simplified schematic of a fiber-containing flexible insulation material 208 that may be used as a wrap and/or liner for ducts, pipes, tanks, equipment, etc., according to embodiments of the present fiber-containing product. In embodiments, the fiber-containing flexible insulation material 208 may include a facer 210 attached to one or more surfaces of the fiber material 212. In further embodiments, materials for the facer 210 may include fire-resistant foil-scrim-kraft facing.

Additional embodiments of the fibrous materials may include low-density fiberglass insulation batt/blanket (e.g. less than about 0.5 lbs/ft³) and high-density fiberglass insulation batt/blanket. Further embodiments may include aircraft insulation, piping insulation, duct boards, duct liner, duct wrap, flexible duct media, pipe insulation, tank insulation, rigid plenum liner, textile duct liner insulation, equipment liner, oven insulation, elevated temperature board, elevated temperature wrap, elevated temperature panel, insulation rolls, exterior foundation insulation board, and marine hull insulation.

In embodiments, the fibrous materials may include construction materials including piping insulation, duct boards (e.g. air duct boards), and building insulation, reinforcement scrim, and roofing membranes, among other construction materials. Additional embodiments may include loose-fill blown insulation, duct liner, duct wrap, flexible duct media, pipe insulation, tank insulation, rigid plenum liner, textile duct liner insulation, equipment liner, oven insulation, elevated temperature board, elevated temperature wrap, elevated temperature panel, insulation batts and rolls, heavy density batt insulation, light density batt insulation, exterior foundation insulation board, and marine hull insulation, among other materials.

In embodiments, the fibrous materials may be characterized by a density of greater than or about 5 kg/m³, greater than or about 10 kg/m³, greater than or about 20 kg/m³, greater than or about 30 kg/m³, greater than or about 40 kg/m³, greater than or about 50 kg/m³, greater than or about 60 kg/m³, greater than or about 70 kg/m³, greater than or about 80 kg/m³, greater than or about 90 kg/m³, greater than or about 100 kg/m³, or any ranges or values therebetween.

Furthermore, in embodiments, the fibrous materials may be thermal insulation batt/blanket characterized by a density greater than or about 2.5 kg/m³, greater than or about 3 kg/m³, greater than or about 3.5 kg/m³, greater than or about 4 kg/m³, greater than or about 4.5 kg/m³, greater than or about 5 kg/m³, greater than or about 6 kg/m³, greater than or about 7 kg/m³, greater than or about 8 kg/m³, greater than or about 9 kg/m³, greater than or about 10 kg/m³, greater than or about 11 kg/m³, greater than or about 12 kg/m³, or any ranges or values therebetween.

In additional embodiments, the fibrous materials may be a composite is duct board characterized by a density greater than or about 30 kg/m³, greater than or about 40 kg/m³, greater than or about 50 kg/m³, greater than or about 60 kg/m³, greater than or about 70 kg/m³, greater than or about 80 kg/m³, greater than or about 90 kg/m³, greater than or about 100 kg/m³, or any ranges or values therebetween.

### Exemplary Systems of Making the Fiber-Containing Products

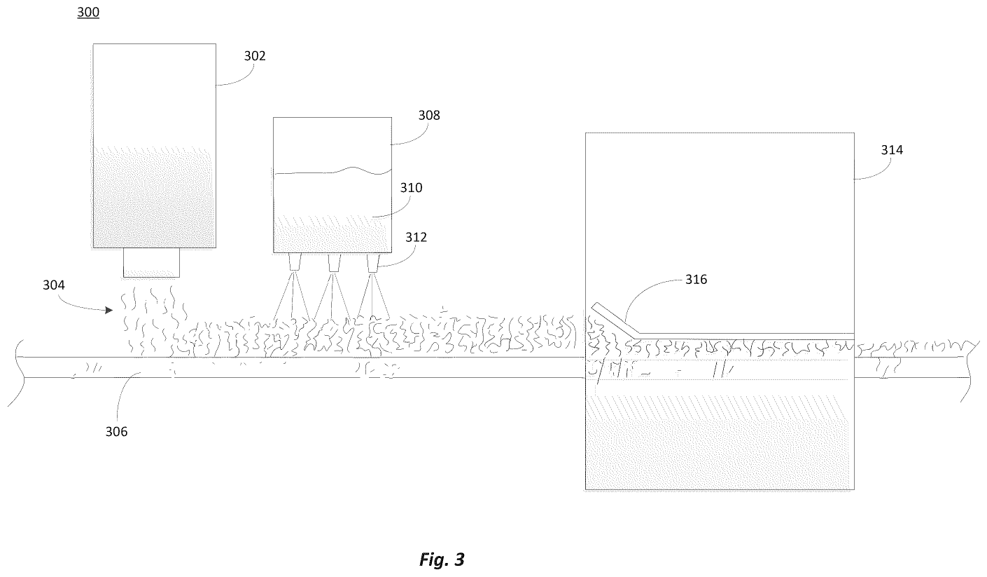

FIG. 3 shows an embodiment of a system 300 for making the present fibrous materials. In embodiments, the system 300 may include a fiber supply unit 302 that supplies the fibers for the fiber-containing product. The fiber supply unit 302 may be filled with pre-made fibers, or may include equipment for making the fibers from starting materials such as molten glass or organic polymers (e.g., a pot and marble production unit). The fiber supply unit 302 may deposit the fibers 304 onto a porous conveyor belt 306 that transports the fibers under the binder supply unit 308.

In embodiments, the binder supply unit 308 contains a liquid uncured binder composition 310, that may be deposited onto the fibers 304. In the embodiment shown, the binder composition 310 may be spray coated onto the fibers 304 with spray nozzles 312. In additional embodiments, other application techniques (e.g. curtain coating, dip coating, knife coating, etc.) may be used in addition to (or in lieu of) the spray coating technique illustrated by nozzles 312.

Furthermore, in embodiments, the binder composition 310 may be applied on fibers 304 to forms a fiber-binder amalgam on the top surface of the conveyor belt 306. The belt 306 may be perforated and/or porous to allow excess binder composition 310 to pass through the belt 306 to a collection unit (not shown) below. The collection unit may include filters and circulation pumps to recycle at least a portion of the excess binder back to the binder supply unit 308.

In embodiments, the conveyor belt 306 may transport the fiber-binder amalgam to an oven 314 where it is heated to a curing temperature and the binder composition starts to cure. The temperature of the oven 314 and the speed of the conveyor belt 306 can be adjusted to control the curing time and temperature of the fiber-binder amalgam. In some embodiments, process conditions may set to completely cure the fiber-binder amalgam. In additional embodiments, process conditions may be set to partially cure the binder-fiber amalgam into a B-staged fiber-containing product.

In still further embodiments, the fiber-binder amalgam may be compressed prior to or during the curing stage. The system 300 shows a fiber-binder amalgam being compressed by passing under a plate 316 that tapers downward to decrease the vertical space available to the curing amalgam. The fiber-binder amalgam emerges from under the plate 316 in a compressed state and has less thickness than when it first made contact with the plate. In embodiments, the taper angle formed between the plate 316 and conveyor belt 306 can be adjusted to adjust the level of compression placed on the fiber-binder amalgam. In the illustrated embodiments, a fiber-containing product that emerges from under plate 316 can be used for a variety of applications, including construction materials such as pipe, duct, and/or wall insulation, among other applications, as discussed above.

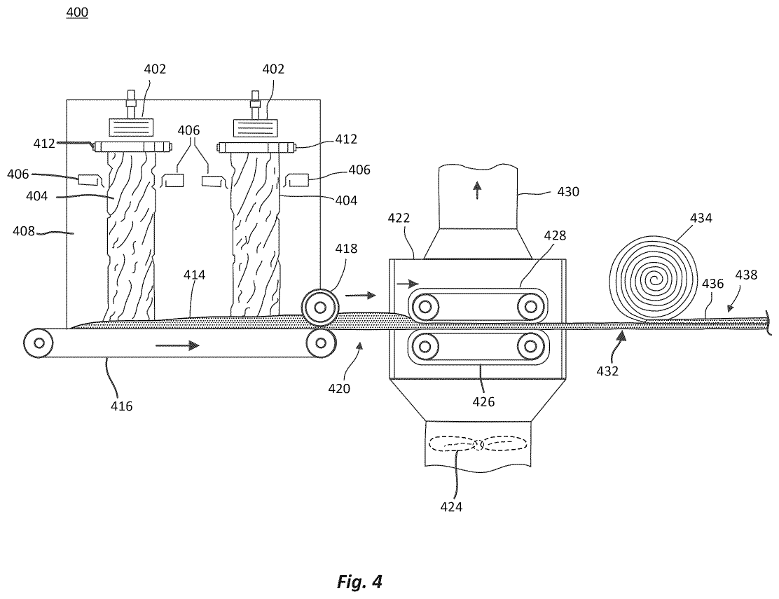

FIG. 4 illustrates a system 400 for making the fibrous materials utilizing the binders discussed herein. The system 400 may include spinners 402 that can be rotated at high speeds to pass molten glass through holes in the circumferential sidewalls of the spinners to form glass fibers. In embodiments, the molten glass may be supplied from a heated tank (not shown) that holds the molten glass. In further embodiments, glass fibers 404 may be emerge from the fiberizing spinners 402 and may be blown in a substantially downward direction. In further embodiments, the glass fibers may be blown in a substantially perpendicular direction to the plane of the spinners 402, by blowers 406 positioned within a forming chamber 408. In additional embodiments, the glass fibers 404 may be made from a single type of glass, while in still further embodiments, they may be made from two or more different types of glass. In yet additional embodiments, glass fibers 404 may include hybrid glass fibers where each individual hybrid fiber may be formed of two or more different glass compositions.

The glass fibers 404 may be contacted with the binder composition while in the forming chamber 408 and while still hot from the glass fiber formation operation. Additionally or alternatively, the binder composition may be sprayed on the glass fibers 404 with an annular spraying rings 412. In further embodiments, the annular spraying ring 412 may provide a substantially uniform coating of the binder composition on the glass fibers 404. In still further embodiments, the glass fibers 404 coated with the binder composition may be formed into a batt of fiber-binder amalgam 414 that have a substantially uniform distribution of the binder composition throughout. In some embodiments, water may be applied to the glass fiber 404 prior to the application of the binder composition to cool the fibers.

The glass fibers 404 coated with the binder composition may be gathered and formed into an uncured fiber-binder amalgam 414 on an endless forming conveyor belt 416 within the forming chamber 408. In embodiments, the forming chamber may pull a vacuum from below the conveyor belt 416 that puts pressure on the fiber-binder amalgam 414 from above the conveyor belt. In yet further embodiments, the residual heat from the glass fibers 404 and the flow of air through the fiber-binder amalgam 414 during the forming operation may volatilize water from the fiber-binder amalgam 414 before it exits the forming chamber 408. In embodiments, the binder composition in the fiber-binder amalgam 414 exiting the forming chamber 408 may have a lower moisture level than the binder composition applied to the glass fibers 404. These lower moisture levels may give the binder composition in the fiber-binder amalgam 414 exiting the chamber a higher viscosity than the fiber-binder amalgam 414 initially formed on the conveyor belt 416.

The fiber-binder amalgam 414 may be compressed while exiting the forming chamber 408 by roller 418. In embodiments, the compressed fiber-binder amalgam 414 may be moved to a transfer zone 420 where the amalgam expands due to the resiliency of the glass fibers. In additional embodiments, the expanded fiber-binder amalgam 414 may be transferred to a curing oven 422 where the amalgam may be heated to a curing temperature for a curing time, according to the times and temperatures discussed above. In embodiments, the curing oven 422 may both dry and heat the fiber-binder amalgam 414 by blowing heated gas through the amalgam. In further embodiments, heated air may be forced though a fan 424 positioned below a lower oven conveyor 426 to dry and heat the fiber-binder amalgam 414 into a mixture of the glass fibers and curing binder. In still further embodiments, the forced heated air may continue through an upper oven conveyor 428 and out of the curing oven 422 through an exhaust conduit 430. The upper and lower conveyors 426 and 428 may compress the curing fiber-binder amalgam 414 to a preset thickness as it is being conveyed though the curing oven 422. In embodiments, a cured and compressed mixture of the glass fibers and cured binder 432 may emerge from the curing oven 422.

The curing oven may be operated at one or more of the temperatures discussed above, which may be a temperature lower than a curing oven temperature utilized for conventional polyacrylic acid based binder systems. In embodiments, the speed of conveyor belt 416 and upper and lower conveyors 426 and 428 may be set to move the fiber-binder amalgam 414 through the curing oven 422 in a preset time. In still further embodiments, the curing fiber-binder amalgam 414 may reside in the curing oven for less than or about 30 minutes, less than or about 25 minutes, less than or about 20 minutes, less than or about 15 minutes, less than or about 10 minutes, less than or about 7.5 minutes, less than or about 5 minutes, less than or about 2.5 minutes, less than or about 1 minute, less than or about 0.5 minutes, or any ranges or values therebetween.

In embodiments, a facing material 434 may be placed on the mixture of glass fibers and cured binder 432 to form a facing layer 436 on the material. In additional embodiments, the combination of the facing layer 436 on the mixture of glass fibers and cured binder 432 may form a fiber-containing product 438. Some non-limiting examples of suitable facing materials 434 may include Kraft paper, a foil-scrim-Kraft paper laminate, recycled paper, and calendared paper. The facing material 434 may be adhered to the surface of the mixture of glass fibers and cured binder 432 by a bonding agent (not shown) to form the fiber-containing product 438. Suitable bonding agents include adhesives, polymeric resins, asphalt, and bituminous materials that can be coated or otherwise applied to the facing material 434. In embodiments, the fiber-containing product 438 may subsequently be rolled for storage and/or shipment or cut into predetermined lengths by a cutting device (not illustrated). Such fiber-containing products 438 may be used, for example, as ductwrap, ductboard, as faced equipment insulation, and as pipe insulation, among other applications. In some embodiments, the mixture of glass fibers and cured binder 432 that emerges from the curing oven 422 may be rolled onto a take-up roll or cut into sections having a desired length instead of being faced with a facing material 434. In still further embodiments, the mixture of glass fibers and cured binder 432 may be slit into layers and by a slitting device and then cut to a desired length (not illustrated).

### EXAMPLES

The following Examples are presented to provide specific representative embodiments of the present invention. The invention is not limited to the specific details as set forth in these Examples.

### Dogbone Preparation and Testing Protocol

As used herein, the “dogbone” test refers to testing on a dogbone-shaped sample that is made by combining the binder compositions of the present disclosure with borosilicate glass beads having an average diameter of 1 mm. The bead-binder composition amalgam is poured into dogbone molds roughly 25 mm wide and 6 mm thick and allowed to cure. The dogbone shaped samples should be cured in an oven at 210° C. for 20 minutes. Each dogbone sample should include about 2.5 wt. % (LOI) of the cured binder. The samples are further divided into unaged samples that are tested directly after being released from the molds and humid-aged samples that are placed in a humidifying oven for 24 hours at 90° F. (32.2° C.) and 90% relative humidity. Each dogbone sample should be tested in the same Instron tensile strength testing apparatus to measure its tensile strength (Harry W. Dietert Col.—Tensile Core Grip Assembly Part No. 610-7CA).

### Cure Rate Testing Protocol

The cure rate and cure temperature of the binder systems was measured using Dynamic Mechanical Analyzer DMA-Q800 equipment from TA instruments. Glass filter paper was loaded with binder solution and inserted in a dual cantilever clamp. The storage modulus was measured as a function of temperature up to 250° C. and cure rate was obtained as relative change in modulus vs temperature (MPa/C).

As used herein, “exotherm onset temperature” is utilized to refer to the temperature at which the temperature of the dedusting oil composition or binder increases rapidly, “lag phase” refers to the time before reaching exotherm onset temperature.

Table 1 illustrates the cure rate at 160° C., peak cure temperature, and the corresponding peak cure rate, for traditional polyols triethanolamine (“TEA”) crosslinked with polyacrylic acid (Control 1), and glycerol crosslinked with polyacrylic acid (Control 2) as compared to beta-hydroxy alkyl amides HAA, TMA-DEA (1:1 mole ratio), and TMA-DIPA (1:1 mole ratio), crosslinked with polyacrylic acid. The carboxylic acid to hydroxyl ratio for all binder systems tested (control and sample) was 2:1. As shown, the binder compositions according to the present technology exhibited significantly faster cure rates at the same cure temperature as compared to the control binders.

TABLE 1

| | Cure Rate | Peak Cure | Peak Cure |
|---|---|---|---|
| | (MPa/C. at | Temperature | Rate |
| Binder | 160° C.) | (° C.) | (MPa/C.) |
| Control 1 | 1.8 | 188 | 9 |
| Control 2 | 2.5 | 176 | 10 |
| PAA-HAA | 9 | 166 | 10 |
| PAA-(TMA-DEA) | 5 | 174 | 10 |
| PAA-(TMA-DIPA) | 4.1 | 176 | 10 |

Table 2 illustrates the cure rate at 160° C., peak cure temperature, and the corresponding peak cure rate for beta-hydroxy alkyl amides crosslinked with polyacrylic acid and poly(acrylic-co-maleic) acid (“PAMA”, mole ratio of 1:1 of acrylic acid to maleic acid). The carboxylic acid to hydroxyl ratio for all binder systems was 2:1. As illustrated, samples of PAMA crosslinked with the beta-hydroxy alkyl amides provided significantly faster cure rates than PAA crosslinked with the corresponding beta-hydroxy alkyl amides. Without wishing to be bound by theory, the lower carboxy equivalent weight of PAMA and/or cis-orientation of carboxylic acid groups in PAMA, may potentially lower the energy of activation for crosslinking with polyol, alone or in addition to the discussion above in regards to the high reactivity carboxyl groups present in PAMA and/or the beta-hydroxy alkyl amides.

TABLE 2

| Binder | | | | |
|---|---|---|---|---|
| | Poly- | Cure Rate | Peak Cure | Peak Cure |
| | carboxylic | (MPa/C.) at | Temperature | Rate |
| Polyol | acid | 160 C. | (C.) | (MPa/C.) |
| HAA | PAA | 9 | 166 | 10 |
| | PAMA | 12 | 162 | 12 |
| TMA-DEA | PAA | −5 | 174 | 10 |
| | PAMA | 8 | 169 | 10 |
| TMA-DIPA | PAA | 4 | 176 | 10 |
| | PAMA | 6.8 | 169 | 8 |

Table 3 shows exotherm onset temperature of control 1 as compared to the binders discussed herein. The exotherm onset temperature was evaluated by manufacturing R-19 insulation batts at 7″ thickness and LOI of 5-5.5%. An area of 40% LOI binder was introduced in the center of the batts with a thermocouple placed in the center of the 40% LOI binder. The batts were put under compression of 2.8 pcf and placed in a 245° C. oven. The time from when the thermocouple reached the oven temperature and the occurrence of the exotherm and the inflection temperature at which the exotherm occurred was taken as the indication of thermal resistance. As can be seen, compared to Control 1, the beta-hydroxy alkyl amide systems provide superior thermal resistance. For instance, as illustrated by the TMA-DEA system sample, there is no exotherm or significantly increased time taken to exotherm as illustrated by the HAA binder system sample.

TABLE 3

| | Exotherm Onset | Exotherm Lag Phase |
|---|---|---|
| Binder | Temperature (° C.) | (seconds) |
| Control 1 | 275 | 3900 |
| PAA-HAA | 282 | 7500 |
| PAA-(TMA-DEA) | No exotherm exhibited | No exotherm |
| PAMA-(TMA-DEA) | No exotherm exhibited | No exotherm |

### Mechanical Performance

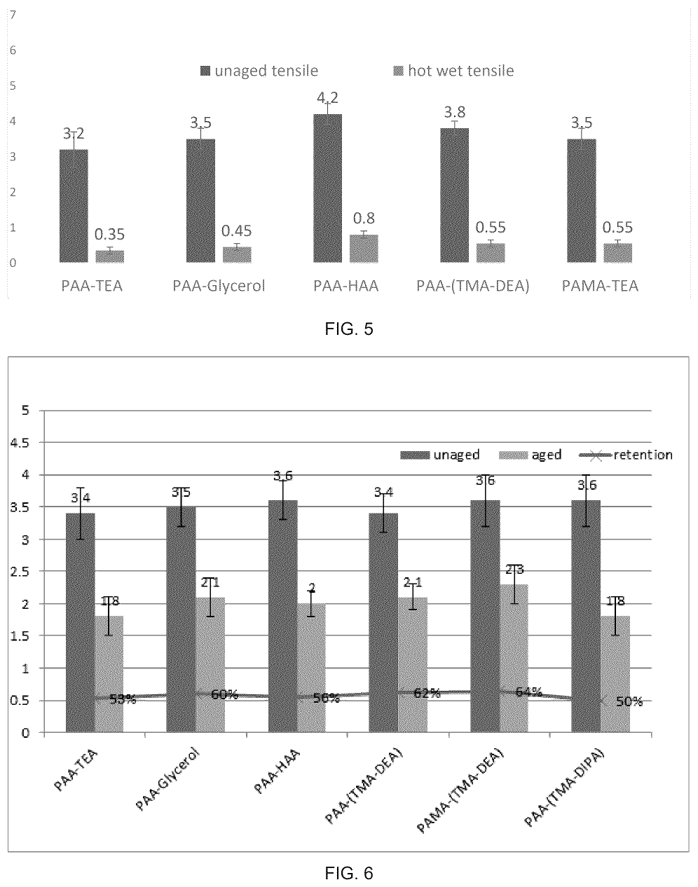

Mechanical performance was evaluated by testing handsheet tensile strength and dogbone testing. FIG. 5 illustrates the handsheet tensile strength of the binders discussed herein as compared to controls 1 and 2, where each sample was cured at 160° C. for two minutes to give an LOA of 10%. FIG. 5 shows the hot-wet tensile strength of handsheets based on the binders discussed herein are significantly higher than traditional binder, which could be attributed to faster cure kinetics at similar curing conditions.

FIG. 6 illustrates the dogbone tensile mechanical performance of the control binders as compared with the binders discussed herein. As illustrated, the mechanical performance of the binders discussed herein do not sacrifice mechanical performance with the improved cure kinetics.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A binder composition for fibrous materials, comprising:
a beta-hydroxy alkyl amide crosslinked with a monomeric or polymeric polycarboxylic acid; and
wherein the binder composition comprises a cure rate of greater than or about 4 MPa/C at 160° C.

2. The binder composition of claim 1, wherein the beta-hydroxy alkyl amide comprises a reaction product of a primary or secondary alkanolamine or alkylalkanolamine and a monobasic or polybasic acid or anhydride.

3. The binder composition of claim 2, wherein the primary or secondary alkanolamine or alkylalkanolamine comprises one or more hydroxy groups in a beta position relative to an amine.

4. The binder composition of claim 3, wherein the primary or secondary alkanolamine or alkylalkanolamine comprises ethanolamine, diethanolamine, propanolamine, isopropanolamine, dipropanolamine, diisopropanolamine, tris(hydroxymethyl)aminomethane, 3-amino-1,2-propanol, 2-amino-1,3-propanol, N-methylethanolamine, N-ethylethanolamine, N-benzylethanolamine, N-isopropylethanolamine, N-butylethanolamine, t-butylethanolamine or a combination thereof.

5. The binder composition of claim 2, wherein the monobasic or polybasic acid or anhydride comprises an aliphatic acid or anhydride, aromatic acid or anhydride, a cyclic acid or anhydride, or a combination thereof.

6. The binder composition of claim 3, wherein the monobasic or polybasic acid or anhydride comprises acetic acid, acetic anhydride, propionic acid, propionic anhydride, benzoic acid, benzoic anhydride, phthalic acid, phthalic anhydride, terephthalic acid, terephthalic anhydride, oxalic acid, oxalic anhydride, succinic acid, succinic anhydride, adipic acid, adipic anhydride, tetrahydro phthalic acid, tetrahydro phthalic anhydride, trimellitic acid, trimellitic anhydride, citric acid, citric anhydride, butane-tetra carboxylic acid, butane-tetra carboxylic anhydride, benzophenone tetra carboxylic acid, benzophenone tetra carboxylic anhydride, or combinations thereof.

7. The binder composition of claim 1, wherein the monomeric or polymeric polycarboxylic acid comprises a copolymer of acrylic acid and maleic acid.

8. The binder composition of claim 1, wherein monomeric or polymeric polycarboxylic acid comprises at least one homopolymer or copolymer comprising citric acid, succinic acid, itaconic acid, maleic acid, butane-tetracarboxylic acid, acrylic acid, maleic acid, itaconic acid, methacrylic acid, fumaric acid, crotonic acid, maleic anhydride, itaconic anhydride, or a combination thereof.

9. The binder composition of claim 1, wherein the binder composition exhibits an exotherm onset temperature of greater than 275° C.

10. The binder composition of claim 1, wherein the binder composition comprises a ratio of carboxyl groups to hydroxyl groups of greater than or about 0.5:1.

11. A fibrous material, comprising:
a cured binder composition, the cured binder composition comprising, a beta-hydroxy alkyl amide crosslinked with a monomeric or polymeric polycarboxylic acid; and
a plurality of fibers;
wherein the binder composition comprises a cure rate of greater than or about 4 MPa/C at 160° C.

12. The fibrous material of claim 11, wherein an unreacted portion of the homopolymer or copolymer of acrylic acid, or the copolymer of acrylic acid and maleic acid forms less than or about 5 wt. % of the cured binder.

13. The fibrous material of claim 11, wherein the plurality of fibers comprises organic fibers, glass fibers, mineral fibers, or combinations thereof.

14. The fibrous material of claim 11, wherein plurality of fibers comprise a fiber batt, a fiber mat, a fibrous nonwoven, or a combination thereof.

15. The fibrous material of claim 11, wherein the fibrous material comprises thermal insulation, acoustic insulation, or a combination thereof.

16. The fibrous material of claim 11, wherein the fibrous material is thermally stable for a time greater than or about 100 minutes at a temperature of greater than or about 230° C.

17. A method of making a fibrous material, comprising:
forming a binder composition comprising:
reacting a monobasic or polybasic acid or anhydride with an alkanolamine or alkylalkanolamine to form a beta-hydroxy alkyl amide, and crosslinking the beta-hydroxy alkyl amide with a monomeric or polymeric polycarboxylic acid;
contacting a plurality of fibers with the binder composition to form an amalgam of the binder composition and the plurality of fibers;
curing the amalgam of the binder composition and the plurality of fibers at a temperature of less than or about 220° C. to form a mat of the plurality of fibers and the binder.

18. The method of claim 17, wherein the fibrous materials comprises a humid-aged tensile strength of greater than or about 1.5 MPa.

19. The method of claim 17, wherein the curing occurs for a time of 30 minutes or less.

20. The method of claim 17, wherein the binder composition exhibits a cure rate of greater than or about 4 MPa/C at 160° C.
